(19) United States
(12) Patent Application Publication
(10) Pub. No.: US 2025/0321028 A1
(43) Pub. Date: Oct. 16, 2025

(54) METHODS AND SYSTEMS FOR TESTING, MODELING AND OPTIMIZING TWO-PHASE FLOW PRODUCED FROM A GEOTHERMAL WELL

(71) Applicant: Schlumberger Technology Corporation, Sugar Land, TX (US)

(72) Inventor: Ashley Bernard Johnson, Cambridge (GB)

(21) Appl. No.: 18/633,072

(22) Filed: Apr. 11, 2024

(51) Int. Cl. F24T 10/10; F24T 10/00

(52) U.S. Cl. CPC F24T 10/10; F24T 2010/56

(57) ABSTRACT

Methods and systems are provided that produce hot fluid from a geothermal well that intersects a geothermal reservoir, which involves using at least one disposable fiber optic cable deployed within the geothermal well to perform optical measurements within the geothermal well; and analyzing and/or processing the optical measurements to control and/or optimize production of hot fluid from the geothermal well. The at least one disposable fiber optic cable can be deployed within the geothermal well to a depth at or near the bottom of the geothermal well.

### FIELD

The present disclosure relates to methods and systems that produce fluids from a geothermal well to extract thermal energy (heat) from a geothermal reservoir.

### BACKGROUND

Geothermal systems are generating considerable interest. Conventional geothermal systems employ a geothermal well that intersects a naturally-occurring geothermal reservoir and produces hot ground water or steam extracted from the geothermal reservoir. The temperature of the geothermal reservoir can range from a few degrees above the ambient conditions on the surface to temperatures beyond 350 degrees Celsius (or 660 Fahrenheit). Such geothermal reservoirs can be found in volcanic settings (such as in Indonesia), in sedimentary settings (such as the German Molasse Basin) and hot wet rocks (e.g., fractured granite with water resources).

The fluid produced at the surface of the geothermal well of a conventional geothermal system can be a two-phase (liquid-gas) fluid due to steam breakout in the produced fluid. The flow of such two-phase fluid in the geothermal well can be difficult to characterize because the harsh high-temperature operating conditions in the geothermal well typically prevent the installation of measuring equipment required for such flow characterization. These difficulties can lead to problems and limitations in effectively controlling the flow of the two-phase fluid in the geothermal well during the operation of the geothermal well, for example, for the purpose of limiting resource depletion.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Methods and systems are provided that produce hot fluid from a geothermal well that intersects a geothermal reservoir, which involves using at least one disposable fiber optic cable deployed within the geothermal well to perform optical measurements within the geothermal well; and analyzing and/or processing the optical measurements to control and/or optimize production of hot fluid from the geothermal well. The at least one disposable fiber optic cable can be deployed within the geothermal well to a depth at or near the bottom of the geothermal well.

In embodiments, the geothermal reservoir can be a conventional geothermal reservoir with at least one naturally-occurring fracture that connects to the geothermal well.

In embodiments, the at least one disposable fiber optic cable can be deployed within the geothermal well through an annulus defined by cemented casing and/or through production tubing.

In embodiments, the optical measurements can include measurements of temperature and pressure at or near the bottom of the geothermal well with the geothermal well shut-in to characterize temperature and pressure of the geothermal reservoir. The temperature and pressure of the geothermal reservoir can be used to generate data that characterizes or relates to enthalpy or heat capacity of the geothermal reservoir.

In embodiments, a surface-located flow meter can be configured to measure mass flow rate of the hot fluid produced by the geothermal well. The measurement of mass flow rate can be used in combination with the measurements of temperature and pressure of the geothermal reservoir to generate data that characterizes or relates to enthalpy or heat capacity of the geothermal reservoir.

In embodiments, the optical measurements can include distributed temperature measurements that provide a temperature profile (i.e., temperature as a function of measured depth) of the geothermal well over time with the geothermal well open. The optical measurements can also include distributed acoustic measurements that provide an acoustic profile (i.e., acoustic noise as a function of measured depth) of the geothermal well over time with the geothermal well open. The temperature profile of the geothermal well and/or the acoustic profile of the geothermal well can be analyzed to identify and/or track the location of a two-phase fluid front in the fluid flowing within the geothermal well to the surface. The optical measurements can provide measurements of temperature and pressure at the location of the two-phase fluid front, and such temperature and pressure measurements can be used to generate data that characterizes or relates to enthalpy or heat capacity of the geothermal reservoir.

In embodiments, a surface-located flow meter can be configured to measure mass flow rate of the hot fluid produced by the geothermal well. The measurement of mass flow rate can be used in combination with the measurements of temperature and pressure at the location of the two-phase fluid front to generate data that characterizes or relates to enthalpy or heat capacity of the geothermal reservoir.

In embodiments, the optical measurements can provide measurements of pressure at or near the bottom of the geothermal well while the geothermal well is shut in and while the geothermal well is open, and such pressure measurements can be used to generate data that characterizes or relates to pressure loss in the geothermal well.

In embodiments, the optical measurements can be processed to generate data that characterizes or relates to enthalpy or heat capacity of the geothermal reservoir and/or pressure loss in the geothermal well. The data that characterizes or relates to enthalpy or heat capacity of the geothermal reservoir and/or the pressure loss in the geothermal well and possibly other operating parameters of the geothermal well can be used to configure a two-phase flow model that simulates the flow of the two-phase fluid in the geothermal well to the surface. The two-phase flow model can be used or executed to control and/or optimize the flow of two-phase fluid produced from the geothermal well at the surface.

In embodiments, the two-phase flow model can be used or executed to determine operating parameters for the wellhead choke of the geothermal well.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIGS. 1A to 1C, collectively, is a flow chart illustrating a workflow for geothermal well production in accordance with the present disclosure;

FIG. 2 is a schematic diagram of a geothermal system in accordance with the present disclosure; and

FIG. 3 is a schematic block diagram of an example computer processing system.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

Embodiments of the present disclosure deploy one or more disposable fiber optic cables within a geothermal well that intersects a geothermal reservoir. The disposable fiber optic cable(s) can be used to perform optical measurements within the geothermal well, and such optical measurements can be analyzed and/or processed to control and/or optimize production of hot fluid from the geothermal well.

In embodiments, the disposable fiber optic cable(s) can be deployed in the geothermal well to a depth at or near the bottom of the geothermal well.

In embodiments, the disposable fiber optic cable(s) can be used to measure temperature and pressure at or near the bottom of the geothermal well with the well shut-in to characterize temperature and pressure of the geothermal reservoir. The temperature and pressure of the geothermal reservoir can be used to generate data that characterizes or relates to enthalpy or heat capacity of the geothermal reservoir. The disposable fiber optic cable(s) can also be used to measure a temperature profile (i.e., temperature as a function of measured depth) of the geothermal well over time and/or an acoustic profile (i.e., acoustic noise as a function of measured depth) of the geothermal well over time with the well open. Such profiles(s) can be analyzed to identify and/or track location of a two-phase fluid front in the fluid flowing within the geothermal well to the surface. The disposable fiber optic cable(s) can also be used to measure temperature and pressure at the location of the two-phase fluid front. Such temperature and pressure measurements can be used to generate data that characterizes or relates to enthalpy or heat capacity of the geothermal reservoir. The disposable fiber optic cable(s) can also be used to measure pressure at or near the bottom of the geothermal well while the well is shut in and while the well is open. Such pressure measurements can be used to generate data that characterizes or relates to pressure loss in the geothermal well. The data that characterizes or relates to the enthalpy or heat capacity of the geothermal reservoir and the pressure loss in the geothermal well as well as other operating parameters of the geothermal well can be used to configure a two-phase flow model that simulates the flow of the two-phase fluid in the geothermal well to the surface. The two-phase flow model can be used or executed to control and/or optimize the flow of the two-phase fluid produced from the geothermal well at the surface.

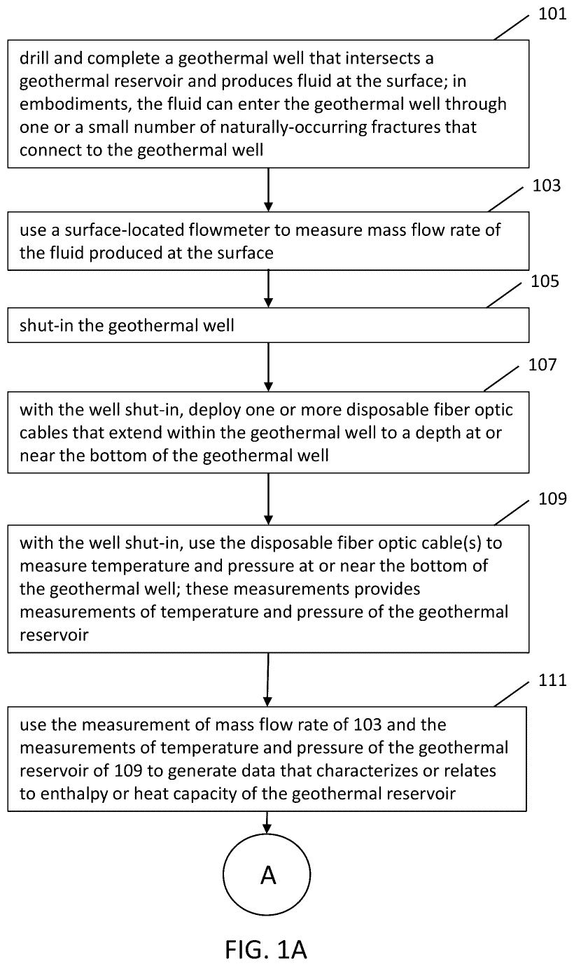

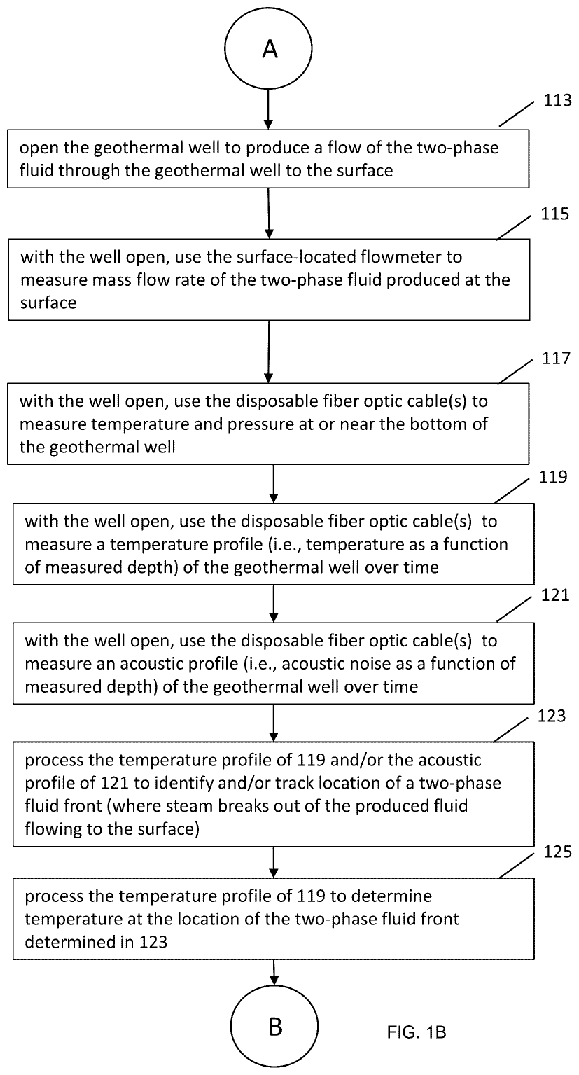

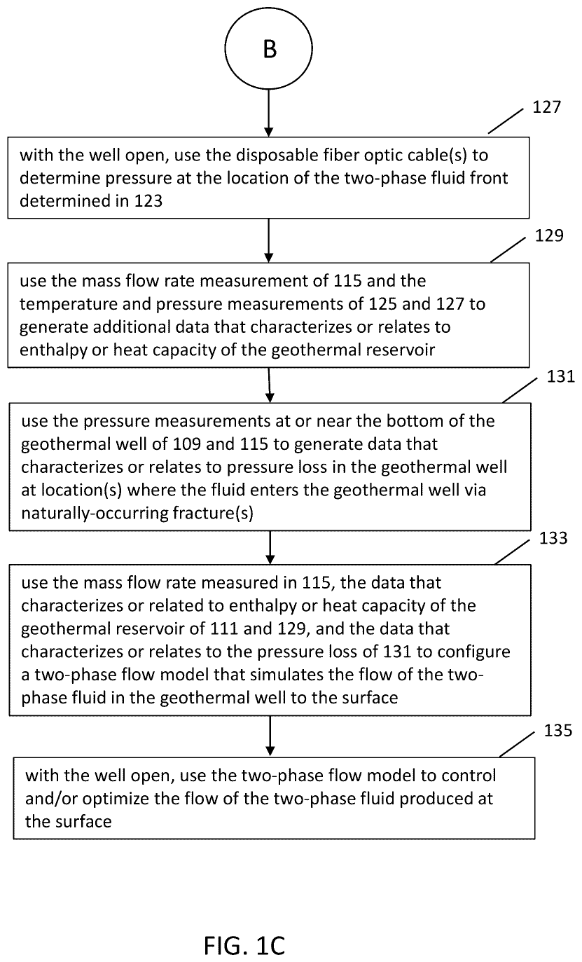

A flow chart illustrating an example workflow in accordance with the present disclosure is shown in FIGS. 1A to 1C.

In block 101, a geothermal well is drilled and completed. The geothermal well intersects a geothermal reservoir and produces hot fluid at the surface. In embodiments, the geothermal reservoir can be a conventional geothermal reservoir where the hot fluid enters the geothermal well through one or a small number of naturally-occurring fractures that connect to the geothermal well. The geothermal well can be completed with an open wellbore or other suitable completion design for the interval where the naturally-occurring fracture(s) connect to the geothermal well. The fluid can flow to the surface through an annulus defined by cemented casing or through production tubing. Alternatively, the workflow can employ a pre-existing geothermal well that intersects a geothermal reservoir and produces hot fluid at the surface.

In block 103, a surface-located flowmeter can be used to measure the mass flow rate of fluid produced at the surface.

In block 105, the geothermal well is shut-in (for example, by closing the wellhead choke of the geothermal well).

In block 107, with the well shut-in, one or more disposable fiber optic cables are deployed in the geothermal well such that the disposable fiber optic cable(s) extend within the geothermal well (e.g., within the annular space defined by casing and/or within production tubing) to a depth at or near the bottom of the geothermal well. In embodiments, such deployment can employ a method similar to the method described in U.S. Pat. No. 9,798,023 where the disposable fiber optic cable(s) are wound around one or more spool(s) with one end of the cable(s) operably coupled to ballast and the other end of the cable(s) operably coupled to surface equipment including one or more optical sources and optical receiving/processing equipment. The ballast and the fiber optic cable(s) can be deployed in the geothermal well by unwinding the fiber optic cable(s) from the spool(s). Alternatively, the disposable fiber optic cable(s) can be deployed in the geothermal using wireline or slickline type cable from surface. This would be slower and require a wireline unit at the wellsite. In other embodiments, the one or more disposable fiber optic cables can be deployed in the geothermal well prior to the well being shut in in block 107.

In embodiments, the fiber optic cable(s) can be configured to support distributed temperature sensing (DTS) measurements, distributed pressure sensing measurements, and distributed acoustic sensing (DAS) measurements, where these measurements are performed at different locations along the fiber optical cable(s). These different measurements can employ well known oilfield sensing techniques. The fiber optic cable(s) can employ coatings or protective sheaths that prevent hydrogen darkening, which is important in high temperature applications.

In block 109, with the well shut-in, the disposable fiber optic cable(s) can be used to measure temperature and pressure at or near the bottom of the geothermal well. These measurements can provide measurements of temperature and pressure of the geothermal reservoir. These measurements can perform well known oilfield fiber optic sensing techniques.

In block 111, the measurement of mass flow rate of 103 and the measurements of temperature and pressure of 109 can be used to generate data that characterizes or relates to enthalpy or heat capacity of the geothermal reservoir. In embodiments, the data that characterizes or relates to enthalpy or heat capacity of the geothermal reservoir as generated in 111 can represent or relate to the specific enthalpy of the geothermal reservoir (enthalpy per unit of mass) and/or the potential enthalpy flux of the geothermal reservoir (which represents the potential heat that can flow through the production well per unit of time). The specific enthalpy can be calculated directly from the temperature and pressure of 109 under the assumption that the fluid in the geothermal reservoir is single phase water/brine. The calculation is known and documented in steam tables-see Saturated Steam-Properties for Pressure in Bar (engineeringtoolbox.com). The specific enthalpy (enthalpy per unit of mass) can be combined with the mass flow rate of 103 to determine data that represents the potential enthalpy flux of the geothermal reservoir. Advantageously, the enthalpy of 111 can be based on temperature and pressure measured at or near the bottom of the geothermal well. At this location, the fluid is more likely to be single phase. As the fluid rises in the geothermal well, the fluid becomes two-phase, and this inversion is not possible without a gas fraction measurement. However, close to the surface in single phase gas, a characterization of enthalpy is possible.

In block 113, the geothermal well is opened (for example, by opening the wellhead choke of the geothermal well) to produce a flow of two-phase fluid through the geothermal well to the surface.

In block 115, with the well open, the surface-located flowmeter can be used to measure mass flow rate of the two-phase fluid produced at the surface.

In block 117, with the well open, the disposable fiber optic cable(s) can be used to measure temperature and pressure at or near the bottom of the geothermal well. These measurements can employ well known oilfield fiber optic sensing techniques.

In block 119, with the well open, the disposable fiber optic cable(s) can be used to measure a temperature profile (i.e., temperature as a function of measured depth) of the geothermal well over time. In embodiments, the temperature profile of the geothermal well can be measured for a given instance in time using DTS. DTS is a technique that measures the temperature at different points along an optical fiber using laser interferometry and Raman scattering.

In block 121, with the well open, the disposable fiber optic cable(s) can be used to measure an acoustic profile (i.e., acoustic noise as a function of measured depth) of the geothermal well over time. In embodiments, the acoustic profile of the geothermal well can be measured for a given instance in time using DAS. DAS is a technique that detects microseismic events by measuring strain at different points along an optical fiber using Rayleigh scattering.

In block 123, the temperature profile of 119 and/or the acoustic profile of 121 can be processed to identify and/or track the location of a two-phase fluid front (where steam breaks out of the produced hot fluid flowing to the surface). For example, as the fluid pressure falls moving up the geothermal well, the gas phase (steam) will break out and the fluid becomes a two-phase (liquid-gas) mixture. The enthalpy of the mixture will remain constant but the temperature will drop. This will manifest itself as an increase in the temperature gradient. The two-phase fluid front (i.e., the point where steam is first formed by breaking out the produced hot fluid) can be identified from the point the temperature first drops or from the change in the temperature gradient as represented by the measured temperature profile. In another example, when the gas phase (steam) breaks out of the fluid, the bubbles of steam will ring, as they move they will collide and generate noise. This increase in noise can be identified from the measured acoustic profile and used as a detector for the two-phase fluid front (i.e., the point where steam is first formed by breaking out the produced hot fluid).

Two-phase flow regimes described in literature include the following:
1) Bubble—in this regime the liquid phase is the continuous phase and occupies most of the pipe volume, and the gaseous phase appears as small bubbles distributed through the liquid.
2) Slug—the liquid phase remains as the continuous phase, but the bubbles have increased in number and size and now join to form a single bubble which form and size approaches the pipe diameter.
3) Transition—in this regime the gaseous phase becomes the continuous phase and some liquid is entrained as small droplets into the gaseous phase.
4) Mist—the gaseous phase is the continuous phase and the liquid is entrained in gas.

The two-phase fluid front of block 123 is the state where the first bubbles of steam form and break out of the liquid phase that flows from the geothermal reservoir through the well toward the surface.

In block 125, the temperature profile of 119 can be processed to determine temperature at the location of the two-phase fluid front determined in 123.

In block 127, with the well open, the disposable fiber optic cable(s) can be used to determine pressure at the location of the two-phase fluid front determined in 123. In embodiments, the pressure gradient will change at the two-phase fluid front (i.e., point of the steam formation). Thus, multiple local pressure measurements (which can be performed with Bragg gratings disposed along a fiber optic cable) can be interpolated to determine the point of inflexion in the pressure gradient and the pressure at that point of inflexion.

In block 129, the measurement of mass flow rate of 115 and the temperature and pressure measurements of 125 and 127 can be used to generate additional data that characterizes or relates to enthalpy or heat capacity of the geothermal reservoir. In embodiments, the additional data that characterizes or relates to enthalpy or heat capacity of the geothermal reservoir as generated in 129 can represent or relate to the specific enthalpy of the geothermal reservoir (enthalpy per unit of mass) and/or the potential enthalpy flux of the geothermal reservoir (which represents the potential heat that can flow through the production well per unit of time). In embodiments, the specific enthalpy of the geothermal reservoir (enthalpy per unit of mass) can be calculated directly from the temperature and pressure of 125 and 127 under the assumption that the fluid at the two-phase fluid front is a single phase water/brine. The function is known and documented in steam tables-see Saturated Steam-Properties for Pressure in Bar (engineeringtoolbox.com). The specific enthalpy (enthalpy per unit of mass) can be combined with the mass flow rate of 115 to determine data that represents the potential enthalpy flux of the geothermal reservoir.

In block 131, the pressure measurements at or near the bottom of the geothermal well of 109 and 117 can be used to generate data that characterizes or relates to pressure loss in the geothermal well at location(s) where the fluid enters the geothermal well via naturally-occurring fracture(s).

In block 133, the mass flow rate measured in 115 and the data that characterizes or relates to the enthalpy or heat capacity of the geothermal reservoir as determined in 111 and 129, and the data that characterizes or relates to pressure loss as determined in 131 can be used to configure a two-phase flow model that simulates the flow of the two-phase fluid in the geothermal well to the surface. The two-phase flow model can employ continuity, momentum and energy equations to represent the two-phase flow. These equations can be used to express total pressure drop up the geothermal well in terms of potential, acceleration and frictional components.

In block 135, the two-phase flow model of 133 can be used to control and/or optimize the flow of the two-phase fluid produced at the surface.

In embodiments, the wellhead choke of the geothermal well can be operated to control the flow of the hot fluid produced from the well. A two-phase flow model can be used to model the flow of the two-phase fluid in the well with the wellhead choke open at different choke pressure settings. In embodiments, the model can account for pressure loss along the flow path from the far field reservoir through the naturally-occurring fracture(s) and entry to the geothermal well and up to the wellhead. The model can be solved to determine an optimal pressure setting for the wellhead choke. The model and the optimal pressure setting for the wellhead choke as determined therefrom can be dependent on data that characterizes or relates to the enthalpy or heat capacity of the geothermal reservoir as determined in 111 and 129 and the data that characterizes or relates to pressure losses as determined in 131 as well as the characteristics and needs of the surface equipment. The flow rate measured in 115 can be used to tune or adjust the two-phase flow model such that the two-phase flow predicted by the model matches the measured flow output from the geothermal well. The wellhead choke can be adjusted to regulate the pressure of the hot fluid produced at the surface such that this pressure corresponds to the optimal pressure setting for the wellhead choke.

Note that the one or more fiber optic cables used for the measurements are disposable. In embodiments, the fiber optic cable(s) will function over time on the order of days and then disintegrate. However, the cost of the deployment of the fiber optic cable(s) and the measurements is very small. Thus, the deployment of the fiber optic cable(s) and the measurements of the methods can be repeated as deemed necessary.

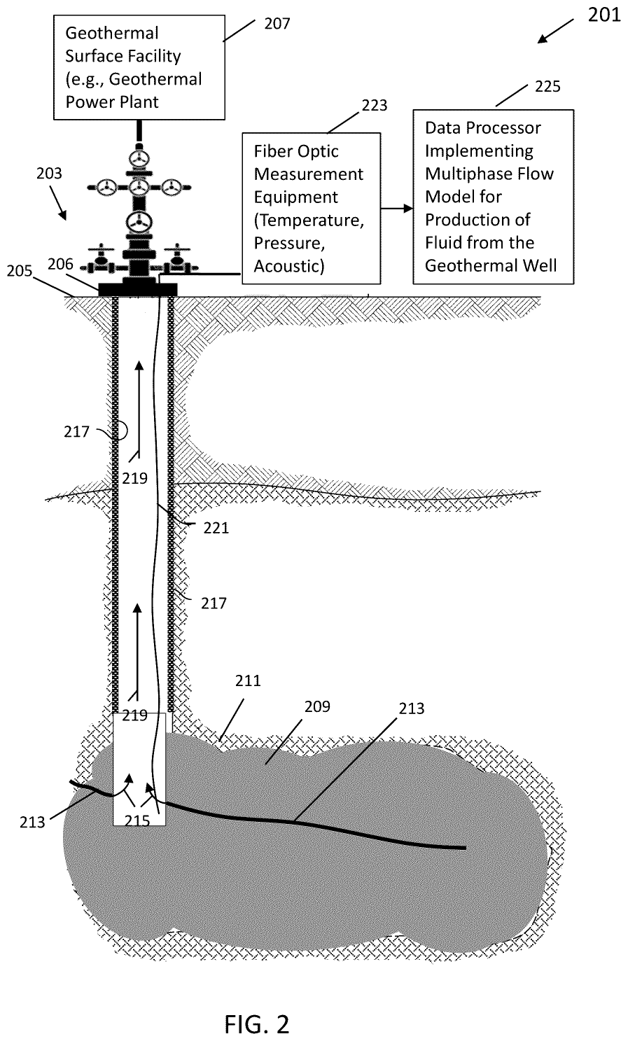

FIG. 2 shows a geothermal system 201 that includes a geothermal well 203 that produces hot fluid at the surface 205. The geothermal well 203 includes a wellhead 206 that is operably coupled to a geothermal surface facility 207 (such as a geothermal power plant) that extracts heat contained in the hot fluid and uses such heat for a desired application, such as electricity production or heating and cooling. The geothermal well 203 intersects a conventional geothermal reservoir 209 formed in a subterranean rock formation 211 and produces hot fluid at the surface 205. In embodiments, the fluid can enter the geothermal well 203 through one or a small number of naturally-occurring fractures 213 that connect to the geothermal well 203 as indicated by arrows 215. In embodiments, the geothermal well 203 can be completed with an open wellbore or other suitable completion design for the interval where the fracture(s) 213 connect to the geothermal well 203. The fluid can flow to the surface 205 through an annulus defined by cemented casing 217 as shown by arrows 219. Alternatively, the fluid can flow to the surface 205 through production tubing (not shown).

The geothermal system 201 further includes one or more disposable fiber optic cables 221 that are deployed within the geothermal well 203 to a depth at or near the bottom of the geothermal well 203. The fiber optic cable(s) 221 are connected to fiber optic measurement equipment 223 located at the surface 205. The fiber optic measurement equipment 223 can include optical sources and receivers that are adapted to perform the optical measurements of the workflow, such as the distributed measurements of temperature, pressure, and acoustic noise using the disposable fiber optic cable(s) 221 as set forth herein.

The geothermal system 201 further includes a data processor 225 operably coupled to the fiber optic measurement equipment 223. The data processor 225 can be configured to analyze, process and/or store electronic data representing the measurements performed by the fiber optic measurement equipment 213 as part of the workflow (e.g., blocks 115 to 133) as described herein. Furthermore, the data processor 225 can be configured to implement a two-phase flow model for the production of fluid from the geothermal well 203. The two-phase flow model can be used to control and/or optimize the flow of the two-phase fluid produced at the surface as described herein.

In embodiments, the wellhead 206 includes a choke that can be operated to control the flow of the hot fluid produced from the geothermal well 203. The two-phase flow model implemented by data processor 225 can be used to model the flow of the two-phase fluid in the geothermal well 203 with the wellhead choke open at different choke pressure settings. The model can be solved to determine an optimal pressure setting for the wellhead choke. The two-phase flow model and the optimal pressure setting for the wellhead choke determined therefrom, can be dependent on data that characterizes or relates to the enthalpy or heat capacity of the geothermal reservoir (as determined in 111 and 129 of the workflow) and/or the data that characterizes or relates to the pressure losses (as determined in 131 of the workflow) as well as the characteristics and needs of the geothermal surface facility 207. The flow rate of the geothermal well (measured in 115 of the workflow) can be used to tune or adjust the two-phase flow model such that the two-phase flow predicted by the model matches the measured flow output from the geothermal well 203. The wellhead choke can be adjusted to regulate the pressure of the hot fluid produced at the surface such that this pressure corresponds to the optimal pressure setting for the wellhead choke.

The geothermal system 201 can include one or more pumps (not shown) to assist in the production of the hot fluid at the surface 203. The pump(s) can be located at the surface or possibly downhole (such as line shaft pumps or electrical submersible pumps). The geothermal well 203 can be a vertical well or have vertical sections as shown. Alternatively, the geothermal well 203 can include lateral or horizonal sections formed by directional drilling.

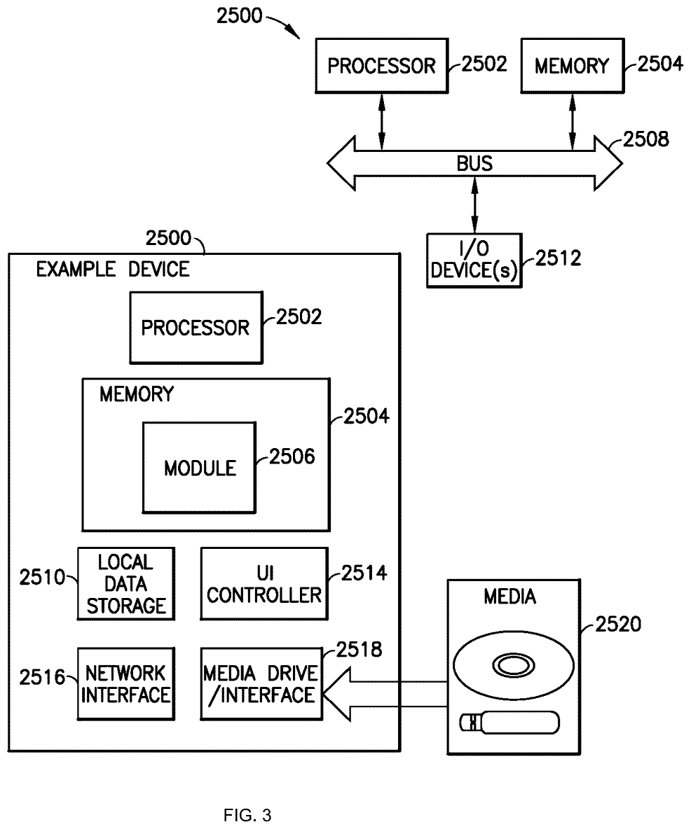

FIG. 3 illustrates an example device 2500, with a processor 2502 and memory 2504 that can be configured to embody data processor 225 of FIG. 2 and implement a two-phase flow model of production of fluid from a geothermal well as part of methods and workflows as discussed in the present application. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more of: computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth). One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network. A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various systems and processes of present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable, and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

Some of the methods and processes described above can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, general-purpose computer, special-purpose machine, virtual machine, software container, or appliance) for executing any of the methods and processes described above.

The computer system may further include a memory such as a semiconductor memory device (e.g., a RAM, ROM, PROM, or Flash-Programmable RAM or ROM), a magnetic memory device (e.g., a diskette or fixed disk), an optical memory device (e.g., a CD-ROM), a PC card (e.g., PCMCIA card), or other memory device.

Some of the methods and processes described above can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

There have been described and illustrated herein several embodiments of methods employing distributed temperature sensing and distributed acoustic sensing for optimization of geothermal well production. While particular configurations have been disclosed in reference to the trajectory and design of the geothermal wells, it will be appreciated that other configurations could be used as well. It will therefore be appreciated by those skilled in the art that yet other modifications could be made to the provided invention without deviating from its spirit and scope as claimed.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with associated function.

What is claimed is:

1. A method for production of hot fluid from a geothermal well that intersects a geothermal reservoir, comprising:
deploying at least one disposable fiber optic cable within the geothermal well;
using the at least one disposable fiber optic cable to perform optical measurements within the geothermal well; and
processing and/or analyzing the optical measurements to control and/or optimize production of hot fluid from the geothermal well.

2. A method according to claim 1, wherein:
the geothermal reservoir comprises a conventional geothermal reservoir with at least one naturally-occurring fracture that connects to the geothermal well.

3. A method according to claim 1, wherein:
the at least one disposable fiber optic cable is deployed within the geothermal well to a depth at or near a bottom of the geothermal well; and/or
the at least one disposable fiber optic cable is deployed within the geothermal well through an annulus defined by cemented casing and/or through production tubing.

4. A method according to claim 1, wherein:
the optical measurements comprise measurements of temperature and pressure at or near the bottom of the geothermal well with the geothermal well shut-in to characterize temperature and pressure of the geothermal reservoir.

5. A method according to claim 4, wherein:
the temperature and pressure of the geothermal reservoir is used to generate data that characterizes or relates to enthalpy or heat capacity of the geothermal reservoir.

6. A method according to claim 5, further comprising:
configuring a surface-located flow meter to measure mass flow rate of the hot fluid produced by the geothermal well, wherein the measurement of mass flow rate is used in combination with the measurements of temperature and pressure of the geothermal reservoir to generate data that characterizes or relates to enthalpy or heat capacity of the geothermal reservoir.

7. A method according to claim 1, wherein:
the optical measurements comprise distributed temperature measurements that provide a temperature profile of the geothermal well over time with the geothermal well open; and/or
the optical measurements comprise distributed acoustic measurements that provide an acoustic profile of the geothermal well over time with the geothermal well open.

8. A method according to claim 7, further comprising:
analyzing at least one of the temperature profile of the geothermal well and the acoustic profile of the geothermal well to identify and/or track location of a two-phase fluid front in the fluid flowing within the geothermal well to the surface.

9. A method according to claim 8, wherein:
the optical measurements provide measurements of temperature and pressure at the location of the two-phase fluid front, and
such temperature and pressure measurements are used to generate data that characterizes or relates to enthalpy or heat capacity of the geothermal reservoir.

10. A method according to claim 9, further comprising:
configuring a surface-located flow meter to measure mass flow rate of the hot fluid produced by the geothermal well, wherein the measurement of mass flow rate is used in combination with the measurements of temperature and pressure at the location of the two-phase fluid front to generate data that characterizes or relates to enthalpy or heat capacity of the geothermal reservoir.

11. A method according to claim 1, wherein:
the optical measurements provide measurements of pressure at or near a bottom of the geothermal well while the geothermal well is shut in and while the geothermal well is open; and
such pressure measurements are used to generate data that characterizes or relates to pressure loss in the geothermal well.

12. A method according to claim 1, wherein:
the optical measurements are processed to generate data that characterizes or relates to at least one of enthalpy or heat capacity of the geothermal reservoir and pressure loss in the geothermal well.

13. A method according to claim 12, wherein:
the data that characterizes or relates to enthalpy or heat capacity of the geothermal reservoir and/or the pressure loss in the geothermal well as well as other operating parameters of the geothermal well are used to configure a two-phase flow model that simulates the flow of the two-phase fluid in the geothermal well to the surface.

14. A method according to claim 13, wherein:
the two-phase flow model is used or executed to control and/or optimize the flow of two-phase fluid produced from the geothermal well at the surface.

15. A method according to claim 14, wherein:
the geothermal well has a wellhead choke; and
the two-phase flow model is used or executed to determine operating parameters for the wellhead choke.

16. A method for production of hot fluid from a geothermal well that intersects a geothermal reservoir, the method comprising:
deploying at least one disposable fiber optic cable within the geothermal well;
using the at least one disposable fiber optic cable to perform optical measurements within the geothermal well;
processing the optical measurements to generate data that characterizes or relates to at least one of enthalpy or heat capacity of the geothermal reservoir and pressure loss in the geothermal well;
configuring a two-phase flow model that simulates the flow of the two-phase fluid in the geothermal well to the surface based on the enthalpy of the geothermal reservoir and/or pressure loss in the geothermal well; and
using the two-phase flow model to control and/or optimize production of hot fluid from the geothermal well.

17. A method according to claim 16, wherein:
the geothermal reservoir comprises a conventional geothermal reservoir with at least one naturally-occurring fracture that connects to the geothermal well.

18. A method according to claim 16, wherein:
the at least one disposable fiber optic cable is deployed within the geothermal well to a depth at or near a bottom of the geothermal well.

19. A method according to claim 16, wherein:
the geothermal well has a wellhead choke; and
the two-phase flow model is used or executed to determine operating parameters for the wellhead choke.

20. A system comprising:
a geothermal well that intersects a geothermal reservoir and produces hot fluid, wherein the geothermal well includes at least one disposable fiber optic cable within the geothermal well;
equipment that uses the at least one disposable fiber optic cable to perform optical measurements within the geothermal well; and
a data processor, operably coupled to the equipment, wherein the data processor is configured to:
process the optical measurements to generate data that characterizes or relates to at least one of enthalpy or heat capacity of the geothermal reservoir and pressure loss in the geothermal well;
configure a two-phase flow model that simulates the flow of the two-phase fluid in the geothermal well to the surface based on the data that characterizes or relates to enthalpy or heat capacity of the geothermal reservoir and/or pressure loss in the geothermal well; and
use the two-phase flow model to control and/or optimize production of hot fluid from the geothermal well.

21. A system according to claim 20, wherein:
the geothermal reservoir comprises a conventional geothermal reservoir with at least one naturally-occurring fracture that connects to the geothermal well.

22. A system according to claim 20, wherein:
the at least one disposable fiber optic cable is deployed within the geothermal well to a depth at or near the bottom of the geothermal well.

23. A system according to claim 20, wherein:
the geothermal well has a wellhead choke; and
the two-phase flow model is used or executed to determine operating parameters for the wellhead choke.
